(19) United States
(12) Patent Application Publication
(10) Pub. No.: US 2017/0041378 A1
(43) Pub. Date: Feb. 9, 2017

(54) SYSTEM AND METHOD FOR SYNCHRONIZED INTERACTIVE MULTIMEDIA PROCESSING AND DELIVERY

(71) Applicants: Shane Patterson, Woodbridge, VA (US); Christopher HIRD, Newark, NJ (US); Parise Yorke, Frederickburg, VA (US)

(72) Inventors: Shane Patterson, Woodbridge, VA (US); Christopher HIRD, Newark, NJ (US); Parise Yorke, Frederickburg, VA (US)

(21) Appl. No.: 15/231,119

(22) Filed: Aug. 8, 2016

Related U.S. Application Data
(60) Provisional application No. 62/202,035, filed on Aug. 6, 2015.

(51) Int. Cl. H04L 29/08

(52) U.S. Cl. CPC H04L 67/06; H04L 67/1095

(57) ABSTRACT

Synchronized playback and distribution of multimedia data within wireless mesh networks that include a gateway device and a remote device. The gateway device may include gateway storage unit with enumerated storage blocks, together forming the file, a transmitter transmitting the enumerated storage blocks from the storage unit. The remote device may include a storage unit with allocated storage block divided into enumerated storage blocks, a first bitmap mapped to the enumerated storage blocks, a receiver receiving an enumerated block and a processing unit for correlating the received enumerated block to a correlated enumerated storage block and correlating an enumerated storage block with a correlated stored bit in the first bitmap, setting the correlated stored bit in the first bitmap, storing the received enumerated block, building a list of missing blocks, and adding to a missing blocks list, and a transmitter transmitting the missing blocks list.

### CROSS-REFERENCE TO RELATED APPLICATION

This application claims priority to U.S. Provisional Application No. 62/202,035 filed Aug. 6, 2015, which is incorporated herein by reference in its entirety.

### BACKGROUND

Technical Field

The embodiments described herein generally relate to the field of digital signal processing and digital image processing, and, more particularly, to synchronized playback of multimedia data and distribution of multimedia data within wireless mesh networks.

Description of the Related Art

Contemporary use of visual effects in the music industry include: static visual effects (such as smoke, lights, and more recently video) that operate strictly according to a pre-programmed routine and synchronized visual effects that use algorithms to synchronize beats and sounds from the musical tracks and turns them into images (e.g., responding to baselines and other features of a track). These visual effects occur in private settings (e.g., pre-defined stations provided to cable subscribers), semi-private settings (e.g., wedding receptions, private parties, etc.) and public settings (e.g., concerts, night clubs, etc.).

Contemporary systems, however, fail to provide an immersive and interactive experience. In semi-private and public settings, for example, there remains a barrier between the professional and the audience. What is needed, therefore, is an interactive system of communication that includes two-way communication and distribution within wireless mesh networks.

### SUMMARY

In view of the foregoing, an embodiment herein provides a system of distributing a file through a wireless connection network comprising a plurality of devices interconnected in the wireless communications network, the plurality of devices comprising: at least one gateway device comprising: a gateway storage unit comprising a plurality of enumerated storage blocks that together form the file; and a gateway transmitter operatively connected to the wireless communications network, and transmitting the enumerated storage blocks from the gateway storage unit; and at least one remote device comprising: a remote device storage unit comprising: an allocated storage block sufficiently sized to store the file; a plurality of enumerated storage blocks that together form the allocated storage block; and a first bitmap comprising a plurality of stored bits, where every stored bit in the first bitmap is initially reset and is correlated to a unique enumerated storage block in the plurality of enumerated storage blocks; a remote device receiver operatively connected to the wireless communications network, and receiving an enumerated block; a remote device processing unit comprising: a correlating unit correlating the received enumerated block to a correlated enumerated storage block in the plurality of enumerated storage blocks and correlating an enumerated storage block with a correlated stored bit in the first bitmap; a map management unit setting the correlated stored bit in the first bitmap; a storing unit storing the received enumerated block to the correlated enumerated storage block; a list building unit building a list of missing blocks, and adding enumerated missing block identifiers to the list of missing blocks for correlated reset stored bits in the first bitmap; and a remote device transmitter operatively connected to the wireless communications network, and transmitting the list of missing blocks.

### BRIEF DESCRIPTION OF THE DRAWINGS

The embodiments herein will be better understood from the following detailed description with reference to the drawings, in which:

FIG. 1 is a diagram illustrating a structure for a wireless communication network;

FIG. 2 is a diagram illustrating communication modes for an exemplary configuration of a wireless network; and

FIG. 3 illustrates a schematic diagram of a computer architecture used in accordance with the embodiments described herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments described herein provide a highly efficient method for synchronized playback and distribution of multimedia data that leverages the characteristics of the wireless mesh network and feedback from users of the mesh network. Files herein refer to collections of data that are generally larger than will fit in an individual wireless transmission. Moreover, embodiments described herein may include a tree-structured networks wherein each device in the network contains a radio transceiver capable of 2-way radio communication with other devices in the network, but is not limited to such a structure. In a tree-structured network, a single device at the “root” of the network is referred to as a gateway device into which new files are introduced for distribution to remote devices (the “branches” or “leaves”) in the network.

Examples of systems containing gateway and remote devices include mobile device connected to a common server, where the common server may be located at a location common to all such devices (such as a night club or concert venue) or the server may reside in a remote location and accessible over the Internet or other common carrier platform.

A wireless mesh networks may comprise large numbers of remote devices that are often difficult to physically access simultaneously and whose primary means of external communication is the wireless network. These remote devices may or may not include public network access (e.g., Internet, PSTN, etc.) and may include two-way wireless communication links that form the wireless mesh network.

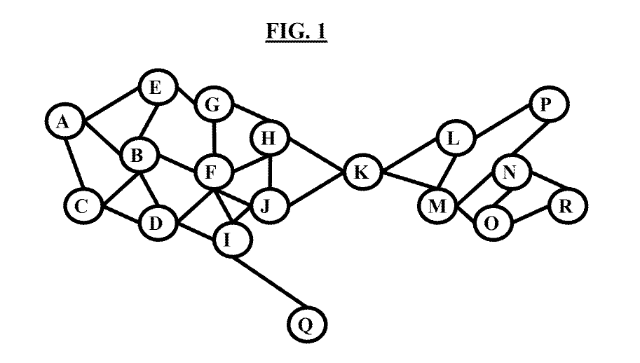

Referring now to the drawings, and more particularly to FIGS. 1 through 3, where similar reference characters denote corresponding features consistently throughout the figures, there are shown preferred embodiments.

Contemporary wireless communication networks (hereinafter “networks”) typically allow simultaneous communication between several independently operating wireless devices. In order to provide simultaneous communication, each device on the network must not interfere with the transmissions of another device. Moreover, devices must ensure that sending and receiving messages are properly tuned and synchronized with respect to each other. Devices capable of interfering with each other's transmissions are referred to as adjacent devices.

In order for transmissions to be properly sent and received, it is important that adjacent devices do not transmit data over the same communication channel at the same time, an event referred to as a collision. Interference typically results when at least two adjacent devices transmit data over the same communication channel at the same time, making it difficult for intended recipients of the transmissions to disentangle originally transmitted data.

A common approach used in radio frequency (hereinafter “RF”) communication to ensure adjacent devices do not transmit over the same communication channel at the same time is to divide the available RF spectrum into fixed quanta called “frequency channels”, divide time into fixed quanta called “timeslots” which are aggregated into fixed groups called “frames”, and allow transmitters to send data using different frequency channels or different timeslots. An example of this type of communication is frequency hopping spread spectrum communication.

In a wireless network where both the RF spectrum and time are divided up, each separate combination of a particular “frequency channel” and a particular “timeslot” constitutes a unique “communication mode” that does not interfere with other communication modes in the network. Where the available RF spectrum is divided into many frequency channels and time is divided into many timeslots, each device in the network has a large number of non-interfering communication modes that it can use to communicate, thus making it possible for a large number of devices to participate in the network without interference. In addition, since the transmissions of two devices can only cause interference if the two devices are within RF range of one another, the likelihood of interference between devices can be further reduced by manipulating the spacing of the devices and the power level of the transmissions within a network.

FIG. 1 illustrates a wireless communication network including a plurality of wireless devices “A” through “R”. Devices that are within RF range of each other (hereinafter referred to as “adjacent devices”) have a line drawn between them. For example, devices “A”, “B”, and “C” are within RF range of each other. Hence, in order to ensure that transmissions involving devices “A”, “B”, or “C” are properly sent and received, adjacent devices may not transmit on the same frequency channel during the same timeslot. In addition, in order for device “A” to successfully transmit data to devices “B” and “C” using a particular frequency channel and a particular timeslot, devices “B” and “C” must tune into the particular frequency channel during the particular timeslot in order to receive the message.

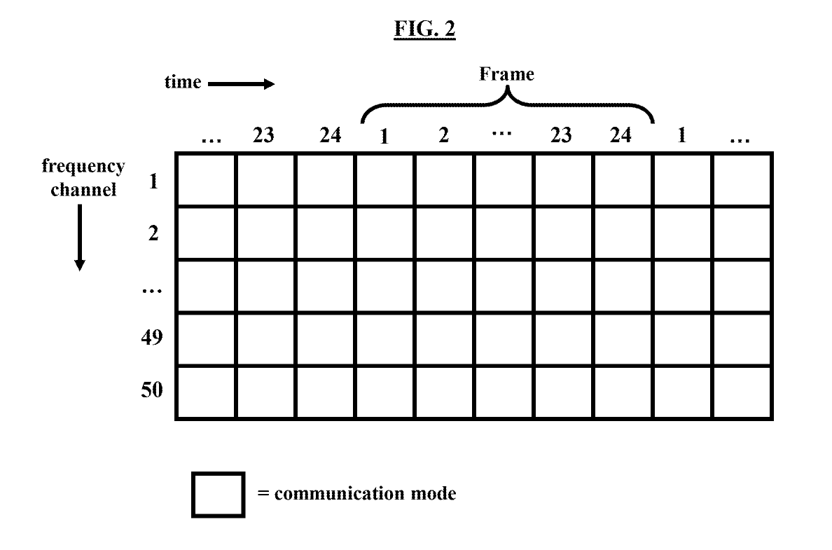

FIG. 2 illustrates an exemplary set of communication modes for a wireless network configuration. In FIG. 2, time is divided into sequential frames comprising 24 timeslots each, and the available RF spectrum is divided into fifty frequency channels. The beginning of a frame will be referred to as a “frame time” or a “synchronized time reference”. Each box in the grid shown in FIG. 2 represents one communication mode. For a particular frame of time, the number of available communication modes is the number of timeslots multiplied by the number of frequency channels, or in this case, 50*24=1200 modes.

Although dividing time and available RF bandwidth helps limit the amount of interference in a wireless network, it creates a complication for the devices of figuring out which frequency channels and timeslots the other devices are using. In order for a communication to succeed, a device transmitting data and a device receiving the transmitted data must both use the same timeslot and frequency channel. Since wireless networks often involve a large number of frequency channels and timeslots, the likelihood that a particular pair of devices will use the same frequency channel/timeslot combination by chance alone is very slim. As a result, it is useful for devices to coordinate their communications in some structured way. For example: networks that use timeslot assignment require mechanisms to synchronize the timing of adjacent transmitters and receivers to ensure successful communication.

In order to coordinate communications between adjacent devices, each device must be aware of the devices adjacent to it; i.e., the device's “adjacencies.” In some wireless networks, pre-planning may allow devices to be informed a priori of adjacent devices; however, in wireless networks where devices are added or removed dynamically, manual intervention or an automatic mechanism for discovering adjacent devices may be necessary. Automatic discovery of adjacent devices typically includes a bi-directional exchange of information between the adjacent devices that facilitates future coordinated communications.

In relatively small networks, communication of information between adjacent devices (e.g., devices A and B in FIG. 1) may be sufficient; however, in large networks, source and destination devices are often not adjacent and the information must traverse numerous intermediate devices to reach its final destination (e.g., information sent from device A to device P in FIG. 1 must traverse numerous other devices). The process of moving information across multiple devices towards a final destination is referred to as “routing”.

Exemplary approaches used for routing include a priori planning (i.e., static routing), which is used when all device adjacencies and/or destinations within a network are fixed and/or known in advance, and various metric based approaches (i.e., dynamic routing), which is used in networks where device adjacencies change dynamically. The routing approach used in a particular network is generally chosen to suit the network's structure and the application performed by the network. For example, networks in smaller environments or environments where there is third party control (such as a wedding reception or private gathering), where most information flows to or from a central point tend to use different approaches than networks such as peer-to-peer networks, where information flows between any two arbitrary devices. Such an approach may be appropriate for larger environments or environments without significant third party control (e.g., concert venues or night clubs).

Common properties used to characterize the performance of a routing method within a network include the method's ability to respond to dynamic changes in the network, its speed of delivery of information, the method's reliability of delivery, efficient use of network bandwidth, and efficient use of device resources (e.g., memory).

The quality of a communication link among devices in a network may vary considerably in quality and may change abruptly. For example, a link that normally works well may become unreliable when an obstruction is introduced between the two devices forming the link. Moreover the quality of communication between an information source and destination separated by intermediate communication links varies with the quality of each intermediate communication link.

Certain routing methods are more reliable than others in the face of unreliable or rapidly changing intermediate links. Reliable routing methods are generally capable of quickly adapting to changing link quality and often send information along multiple simultaneous paths in order to increase the chances for proper delivery. Methods that send information along multiple simultaneous paths trade some network bandwidth and resource efficiency for increased reliability.

Network applications may attempt to compensate for lost network bandwidth and resource efficiency through efficient encoding of information. For example, the network applications may compress the information, or they may attempt to minimize the amount of overhead information sent.

For large RF monitoring and control networks, at least the above issues must be coordinated and balanced to yield a system that is reliable, efficient, and easy to maintain.

Many networks maintain a map of paths stored in the bridging device that must be updated as the quality and presence of network paths change. A central controller in the bridging device specifies an optimal path for data to traverse from each wireless device to the central controller. In networks with dynamically changing links and relatively long communication latencies, maintaining centralized path maps makes it both difficult and slow to respond to changes in the network, particularly when dealing with compromised links and large topologies.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein may comprise hardware and software elements, wherein the embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

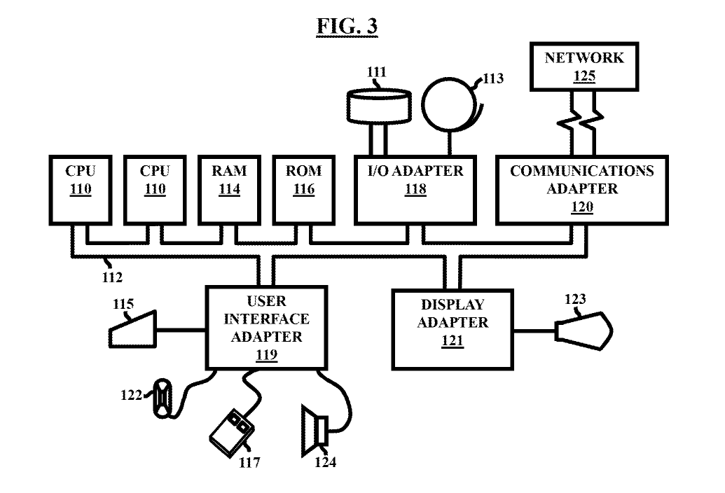

A representative hardware environment for practicing the embodiments herein is depicted in FIG. 3. This schematic drawing illustrates a hardware configuration of an information handling/computer system in accordance with the embodiments herein. The system comprises at least one processor or central processing unit (CPU) 110. The CPUs 110 are interconnected via system bus 112 to various devices such as a random access memory (RAM) 114, read-only memory (ROM) 116, and an input/output (I/O) adapter 118. The I/O adapter 118 can connect to peripheral devices, such as disk units 111 and tape drives 113, or other program storage devices that are readable by the system. The system can read the inventive instructions on the program storage devices and follow these instructions to execute the methodology of the embodiments herein. The system further includes a user interface adapter 119 that connects a keyboard 115, mouse 117, speaker 124, microphone 122, and/or other user interface devices such as a touch screen device (not shown) to the bus 112 to gather user input. Additionally, a communication adapter 120 connects the bus 112 to a data processing network 125, and a display adapter 121 connects the bus 112 to a display device 123 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system of distributing a file through a wireless connection network comprising a plurality of devices interconnected in said wireless communications network, said plurality of devices comprising:
at least one gateway device comprising:
a gateway storage unit comprising a plurality of enumerated storage blocks that together form said file; and
a gateway transmitter operatively connected to said wireless communications network, and transmitting said enumerated storage blocks from said gateway storage unit; and
at least one remote device comprising:
a remote device storage unit comprising:
an allocated storage block sufficiently sized to store said file; and
a plurality of enumerated storage blocks that together form said allocated storage block;
a remote device receiver operatively connected to said wireless communications network, and receiving an enumerated block;
a remote device processing unit comprising:
a storing unit storing said received enumerated block to said correlated enumerated storage block;
a list building unit building a list of missing blocks, and adding enumerated missing block identifiers to said list of missing blocks for correlated reset stored bits in said first bitmap; and
a remote device transmitter operatively connected to said wireless communications network, and transmitting said list of missing blocks.
